(19) United States
(12) Patent Application Publication
(10) Pub. No.: US 2020/0153178 A1
(43) Pub. Date: May 14, 2020

(54) WALL MOUNTED POWER SUPPLY DEVICE

(71) Applicant: Long ZHANG, Suzhou (CN)

(72) Inventors: Yingbin Zhang, Suzhou (CN); Yuyong Zhao, Suzhou (CN); Guangwu Du, Suzhou (CN)

(73) Assignee: Long ZHANG, Suzhou (CN)

(21) Appl. No.: 16/260,848

(22) Filed: Jan. 29, 2019

(30) Foreign Application Priority Data
Nov. 9, 2018 (CN) 201811328263.X
Nov. 9, 2018 (CN) 201821840642.2

(51) Int. Cl. H01R 25/00; H01R 27/02; H02J 7/00; H01R 13/66; H01R 24/30; H01R 24/60

(52) U.S. Cl. CPC H01R 25/006; H01R 27/02; H01R 24/60; H01R 13/6633; H01R 24/30; H02J 7/0042

(57) ABSTRACT

A wall mounted power supply device includes a housing, a transformer unit, including an input winding and at least one output winding; and at least one output circuit corresponding to the at least one output winding. Each output circuit includes: a rectifier unit, coupled to the output winding, to rectify a current of the output winding to generate a DC voltage signal; a DC-to-DC converter, to generate an output signal at an output connector based on the DC voltage signal. The transformer unit and the rectifier unit are sealed within the housing by a thermal adhesive to form a sealed integral unit with the housing. The device has a simple circuit design, is low cost and easy to install, and reliable.

### BACKGROUND OF THE INVENTION

### Field of the Invention

This invention relates to power outlet devices, and in particular, it relates to a power outlet for supplying power to home electrical appliances.

### Description of Related Art

With the wide spread of home electrical appliances, the demand for power supplies in homes increases as well. Power supplies not only provide power outlets in a convenient manner, they often have multiple functions. For example, many power supplies for household use have USB power supply functions; i.e., the power supply has USB (Universal Serial Bus) connectors on their housing, which are coupled to circuitry inside the housing to provide USB power. Such devices can provide power to charge devices such as mobile phones, tablet computers, MP3 players, etc., which require power supplies that comply with the USB protocol. For power receptacles installed in walls, because their size are governed by standards, the space restraints affect the placements of the electrical components inside, which often limit the functions that can be provided by the power receptacles. Thus, conventional wall receptacles tend to provide a limited number of sockets and/or only one voltage. When a receptacle needs to include a USB outlet, the problems are more acute, including the inability to increase output power, tendency to heat up, inability to provide two DC voltages simultaneously (e.g. 5V and 9V, 12V and 20V), etc. High power and multiple USB socket receptacles typically only provide sockets of a single voltage in parallel, and cannot provide multiple different voltages simultaneously.

### SUMMARY

Accordingly, the present invention is directed to a wall mounted power receptacle that provides multiple output sockets with multiple different DC (direct current) voltages.

In one aspect, the present invention provide a wall mounted power supply device, which includes: a housing; a transformer unit, including an input winding and at least one output winding; and at least one output circuit corresponding to the at least one output winding, wherein each output circuit includes: a rectifier unit, coupled to the corresponding output winding, configured to rectify a current of the output winding to generate a DC (direct current) voltage signal; and a DC-to-DC converter, configured to generate an output signal at an output connector based on the DC voltage signal generated by the rectifier unit, wherein the transformer unit and the rectifier unit are sealed within the housing by a thermal adhesive to form a sealed integral unit with the housing.

In one embodiment, the rectifier unit rectifies the current on the output winding so that the output winding outputs the DC voltage signal; or the rectifier unit receives a voltage signal output by the output winding and generates the DC voltage signal based thereon.

In one embodiment, the output circuit further includes a protocol unit, configured to recognize a charging protocol of a device being charged at the output connector, and to control a voltage of the output signal at the output connector according to the charging protocol.

In one embodiment, the transformer unit further includes a pulse width modulation unit, coupled to the input winding, configured to control a time duration of sustained current flow in the input winding.

In one embodiment, the transformer unit further includes a power supply winding, coupled to the pulse width modulation unit, configured to supply an enable signal to the pulse width modulation unit.

In another aspect, the present invention provides a wall mounted power supply device, which includes: a housing; a transformer unit, including an input winding and an output winding; a rectifier unit, coupled to the output winding, configured to rectify a current of the output winding to generate a DC (direct current) voltage signal; and at least two output circuits coupled in parallel, configured to respectively generate independent output signals at respective output connectors based on the DC voltage signal, wherein each output circuit includes a DC-to-DC converter configured to convert the DC voltage signal, wherein the transformer unit and the rectifier unit are sealed within the housing by a thermal adhesive to form a sealed integral unit with the housing.

In one embodiment, the rectifier unit rectifies the current on the output winding so that the output winding outputs the DC voltage signal; or the rectifier unit receives a voltage signal output by the output winding and generates the DC voltage signal based thereon.

In one embodiment, the output circuit further includes a protocol unit, configured to recognize a charging protocol of a device being charged at the output connector, and to control a voltage of the output signal at the output connector according to the charging protocol, wherein the DC-to-DC converter and the protocol unit are sealed in the housing by the thermal adhesive.

In one embodiment, the transformer unit further includes a pulse width modulation unit, coupled to the input winding, configured to control a time duration of sustained current flow in the input winding; and a power supply winding, coupled to the pulse width modulation unit, configured to supply an enable signal to the pulse width modulation unit.

In another aspect, the present invention provides a wall mounted power supply device, which includes: a housing; a first circuit board assembly, including: a transformer unit mounted on a first circuit board, including an input winding and an output winding coupled to each other; and a rectifier unit, mounted on the first circuit board, coupled to the output winding, configured to rectify a current of the output winding to generate a DC (direct current) voltage signal; and a second circuit board assembly, including: an output connector; and a DC-to-DC converter, mounted on a second circuit board, configured to convert the DC voltage signal to generate an output signal at the output connector; wherein the first circuit board assembly is sealed within the housing by a thermal adhesive to form a sealed integral unit with the housing.

In one embodiment, the second circuit board assembly further includes a protocol unit, configured to recognize a charging protocol of a device being charged at the output connector, and to control a voltage of the output signal at the output connector according to the charging protocol.

In one embodiment, the DC-to-DC converter is mounted on a first side of the second circuit board, and the output connector is mounted on a second side of second circuit board opposite the first side.

In one embodiment, the second circuit board assembly further includes a board member mounted on the second side of the second circuit board, wherein the board members is perpendicular to the second circuit board, and wherein the output connector is mounted on the board member.

In one embodiment, the DC-to-DC converter and the protocol unit are sealed in the housing by the thermal adhesive.

The wall mounted power supply device according to embodiments of the present invention employs independent secondary winding and related circuits, so that the same transformer can output multiple different voltages. Meanwhile, by forming a potting structure using a material with high thermal conductivity, heat dissipation is improved, and the structure can further provide waterproof, dust proof, moisture proof, vibration resistance, drop impact resistance, fire resistance, and high heat dissipation functions. The installation of the wall mounted power supply device is similar to that of conventional power supply products, so it does not require extra manual handling. The product according to embodiments of the present invention provide more functions, higher power for the same physical size, and better user experience.

### BRIEF DESCRIPTION OF THE DRAWINGS

Preferred embodiments of the present invention are described with reference to the drawings. These drawings are provided to aid in the understanding of the principles of the invention, so they only illustrate essential components. These drawings are not necessarily to scale. In these drawings, like reference symbols represent like features.

FIG. 1 schematically illustrates the electrical circuit configuration of a power supply device according to a first embodiment of the present invention.

FIGS. 1A-A and 1A-B are a detailed circuit diagram which exemplifies the embodiment of FIG. 1.

FIG. 2 schematically illustrates the electrical circuit configuration of a power supply device according to a second embodiment of the present invention.

FIGS. 2A-A, 2A-B and 2A-C are a detailed circuit diagram which exemplifies the embodiment of FIG. 2.

FIG. 3 schematically illustrates the electrical circuit configuration of a power supply device according to a third embodiment of the present invention.

FIGS. 3A-A, 3A-B and 3A-C are a detailed circuit diagram which exemplifies the embodiment of FIG. 3.

FIG. 4 illustrates an electrical circuit according to embodiments of the present invention.

FIGS. 4A-A, 4A-B and 4A-C are a detailed circuit diagram which exemplifies the embodiment of FIG. 4.

FIG. 5A illustrates an electrical circuit board of a wall-mounted power receptacle according to an embodiment of the present invention.

FIG. 5B illustrates an assembly of a wall-mounted power receptacle according to an embodiment of the present invention.

### DETAILED DESCRIPTION OF PREFERRED EMBODIMENTS

Preferred embodiments of the present invention are described below with reference to the drawings. The drawings illustrate embodiments of the invention using specific examples. The illustrated embodiments are not all possible embodiments of the invention. It should be understood that, without deviating from the spirit of the invention, other embodiments may be provided, and the structure and/or logic of the illustrated embodiments may be modified. Therefore, the specific descriptions below are not limiting, and the scope of the invention is defined by the claims.

Through experimentation, the inventors discovered that conventional wall receptacles have the following problems: low output power, susceptibility to heating, and poor compatibility. When USB output sockets are provided on the receptacle, the above problems are more severe. To provide higher output power and/or multiple USB output sockets, conventional power supply devices typically provide a single voltage and then use parallel internal circuits for the multiple sockets, and cannot provide multiple different voltage outputs simultaneously.

Moreover, some conventional power supply devices provide separate components within the housing to achieve an additional set of independent power supplies having the same function as the first set, i.e., all components are doubled are arranged independently, causing serious electromagnetic interference. Further, because the components are disposed close to each other in space, the heat they generate can affect each other, and heat dissipation is difficult, which limits the power that can be supplied. Still further, conventional power supply devices are costly and complicated to manufacture. The result of providing multiple sets of components is that the total weight is increased, often over 50% more than other typical power receptacles. They also suffer from poor results in impact resistance and fall tests, which affect their use.

Embodiments of the present invention use a modular design, and uses multiple DC-to-DC converters to achieve multiple outputs with different voltages using a single transformer. Further, the interior of the device is filled with heat conductors, to allow heat to be sufficiently dissipated.

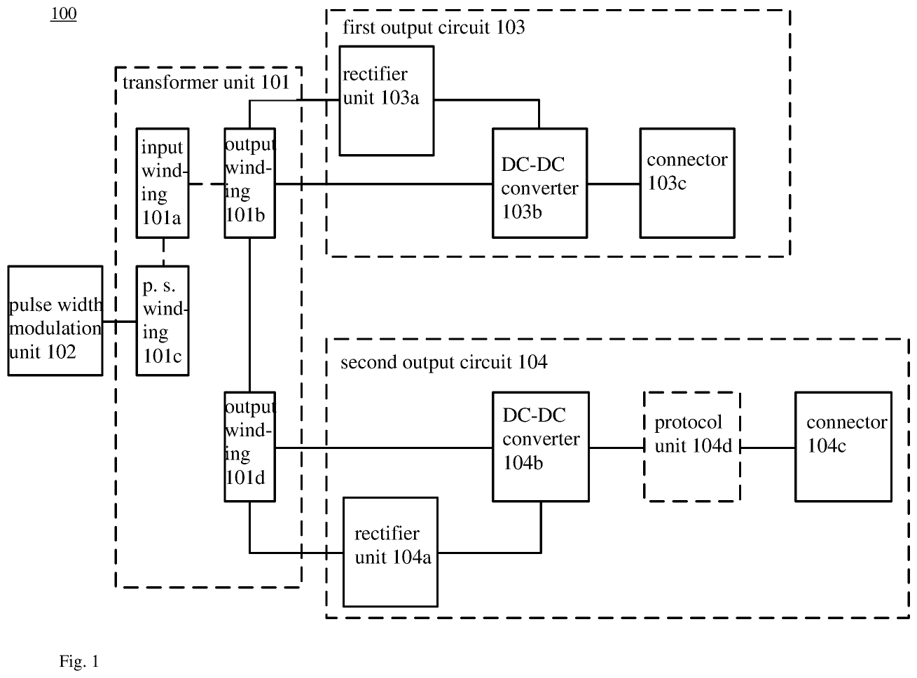

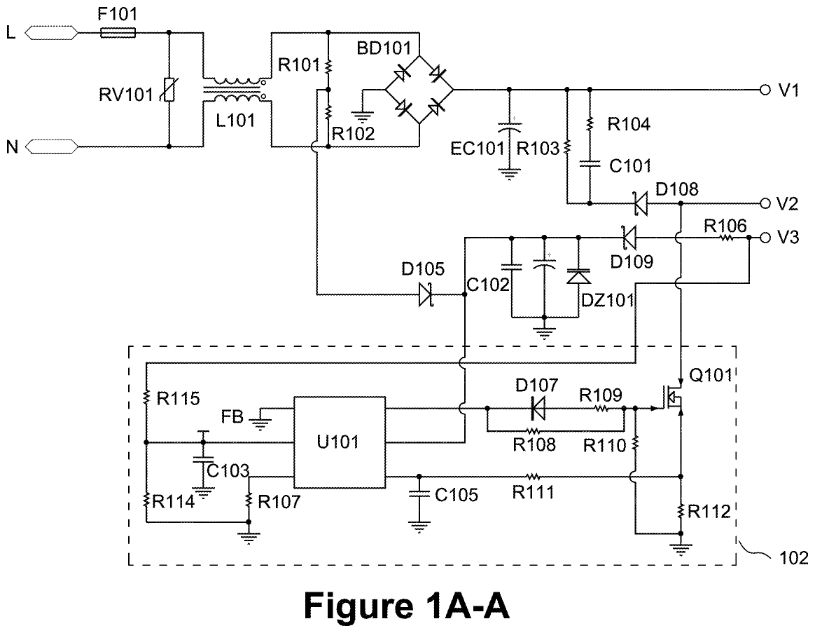

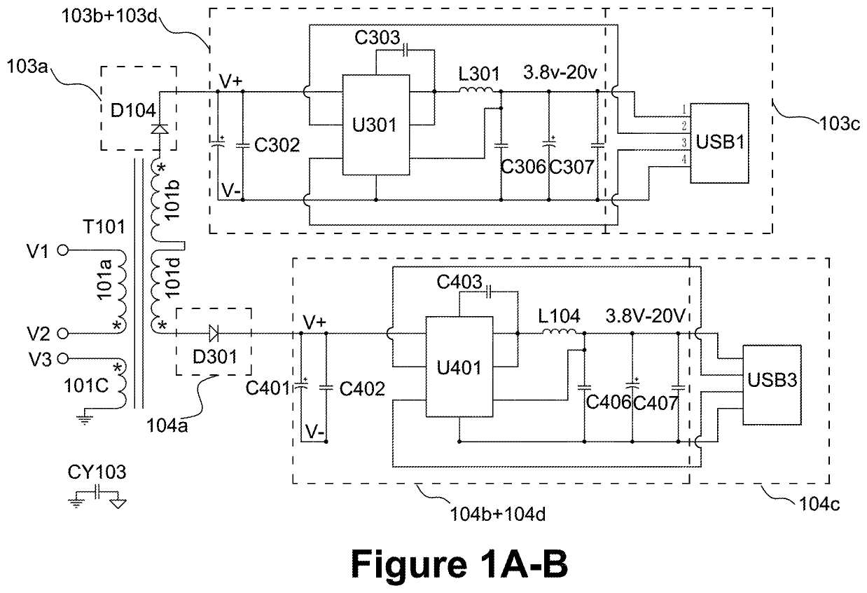

To better understand the invention, refer to FIG. 1, which schematically illustrates the electrical circuit configuration of a power supply device according to a first embodiment of the present invention.

As shown in FIG. 1, the power supply device 100 includes a transformer unit 101, a pulse width modulation unit 102, a first output circuit 103 and a second output circuit 104.

Specifically, the transformer unit 101 may include input winding 101a, first output winding 101b and power supply winding 101c. The input winding 101a and the first output winding 101b are coupled to each other by electromagnetic coupling to transmit power and supply voltage. The power supply winding 101c is coupled to the pulse width modulation unit 102, to provide an enabling signal to the pulse width modulation unit 102.

The transformer unit 101 further includes a second output winding 101d which is coupled in series to the first output winding 101b, such that the second output winding 101d can output a higher voltage signal.

The pulse width modulation unit 102 is coupled between the input winding 101a and the ground via a switch (e.g. a transistor), and functions to control the time duration of sustained current flow in the input winding 101a, thereby adjusting the voltage on the windings.

The first output circuit 103 includes a rectifier unit 103a, a DC-to-DC converter 103b, and connector 103c. The rectifier 103a is coupled to the first output winding 101b, to rectify the current on that winding to generate a first DC voltage signal. The DC-to-DC converter 103b (a device that converts a signal from one DC voltage to another, higher or lower DC voltage) is coupled to rectifier 103a, and based on the first DC voltage signal, generates a first output voltage signal at the connector 103c, e.g., 5V, 9V, 12V, or 20V, etc.

Similarly, the second output circuit 104 includes a rectifier 104a, a DC-to-DC converter 104b, connector 104c, and a protocol unit 104d. The rectifier 104a is coupled to the second output winding 101d, to rectify the current on that winding to generate a second DC voltage signal. The DC-to-DC converter 104b (for raising or lowering the DC voltage) is coupled to rectifier 104a, and based on the second DC voltage signal, generates an input voltage signal for the protocol unit 104d.

As different electrical appliances follow different charging protocols, the protocol unit 104d is configured to recognize the charging protocol of different devices to be charged, and based on it, controls the voltage of the second voltage signal output at the connector 104c. For example, when the arching protocol corresponds to a charging signal of 12V, the protocol unit 104d can provide a 12V voltage at connector 104c based on the charging protocol.

The rectifiers 103a and 104a rectify the current on the respective output windings, so that the output windings output DC current signals. Alternatively, the rectifiers may receive the voltage signal output by the respective output windings, to generate corresponding DC voltage signals and supply them to the respective DC-to-DC converters.

In practical implementations, the transformer unit and the rectifier unit are integrally sealed in the housing of the power supply device body by filling the housing with a thermal adhesive (potting), to form a sealed integral piece with the housing. The pulse width modulation unit and the input winding can also be included in the transformer unit and sealed in the housing by potting. The transformer unit may also include other components such as resistors, capacitors, transistor switches, etc.

FIGS. 1A-A and 1A-B are a detailed circuit diagram which exemplifies the embodiment of FIG. 1. Nodes V1, V2, and V3 in FIGS. 1A-A and 1A-B denote common nodes. In FIGS. 1A-A and 1A-B, the components 101a, 101b, 101c, 101d, 102, 103a, 103b, 103c, 104a, 104b, 104c, and 104d correspond to the components with the same reference symbols in FIG. 1. Note that the first output circuit 103 in FIGS. 1A-A and 1A-B contains a protocol unit 103d, similar to the protocol unit 104d in the second output circuit 104.

The various components shown in FIGS. 1A-A and 1A-B are briefly described below. The rectifier bridge BD101 and capacitor EC101 supply the input winding 101a. The power transistor Q101 is a switch that controls the input power. Control chip U101 receives a signal provided by the transistor Q101, and controls the duty cycle and drives the transistor Q101 accordingly. The transformer T101 includes windings 101a-101d. The Schottky rectifiers D301 and D401 convert high frequency AC (alternating current) current to DC current respectively. The charting protocol chips U301 and U401 communicate with the device being charged to determine the required charging voltage and current.

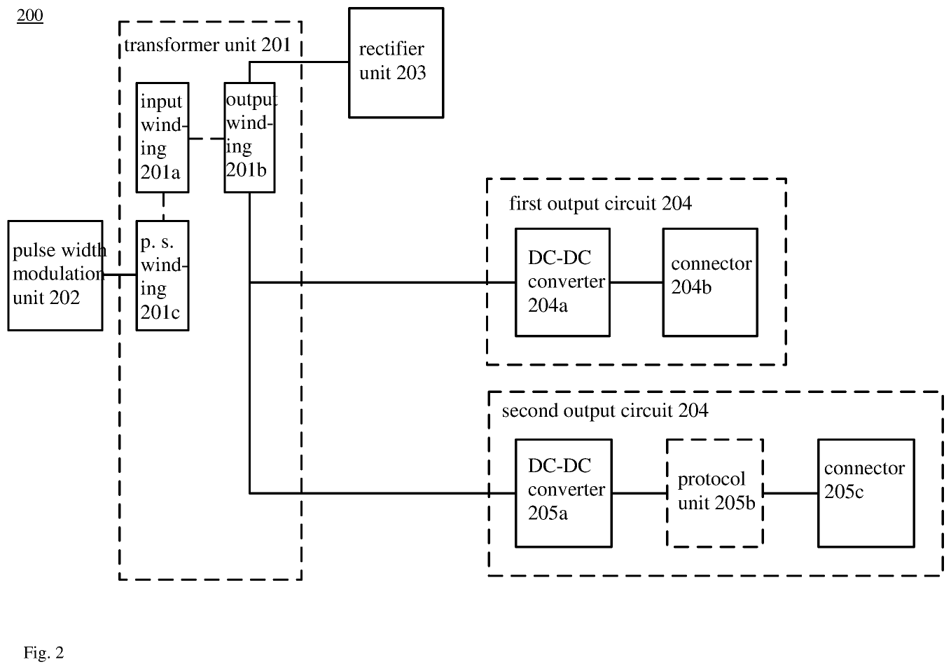

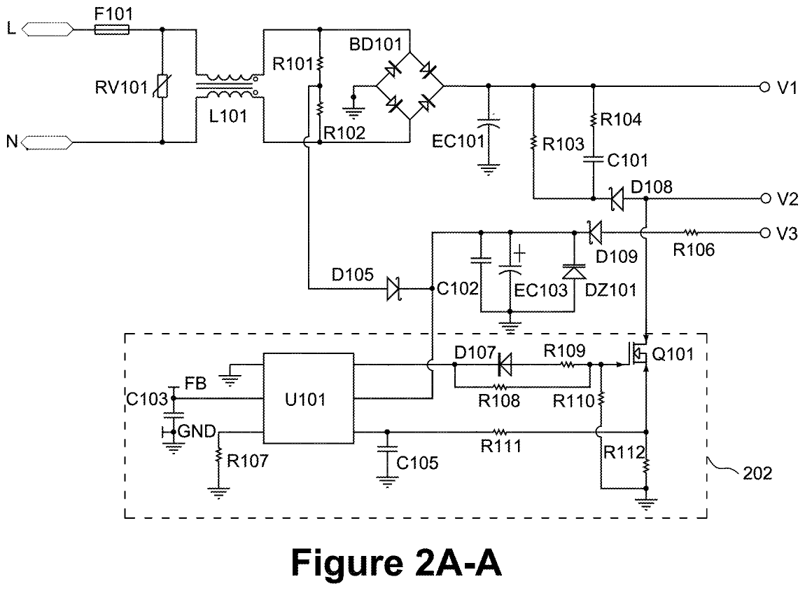

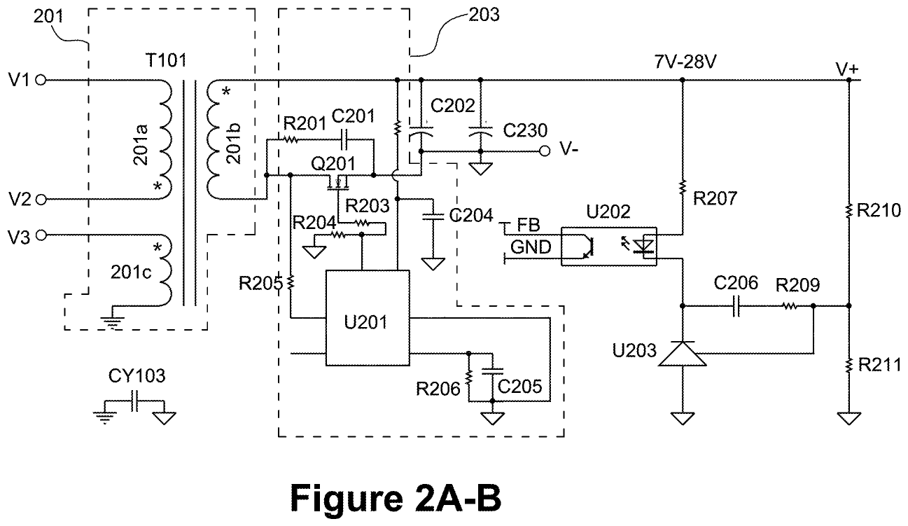

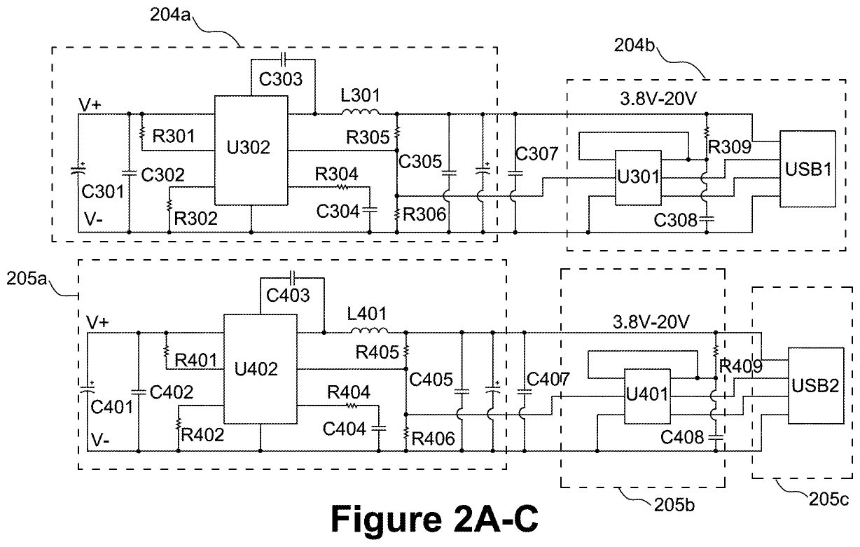

FIG. 2 schematically illustrates the electrical circuit configuration of a power supply device according to a second embodiment of the present invention.

As shown in FIG. 2, the power supply device 200 includes transformer unit 201, pulse width modulation unit 202, rectifier unit 203, first output circuit 204, and second output circuit 205. The first output circuit 204 includes a DC-to-DC converter 204a, and connector 204b. The second output circuit 205 includes a DC-to-DC converter 205a, protocol unit 205b and connector 205c.

The transformer unit 201 includes input winding 201a, first output winding 201b and power supply winding 201c. The input winding 201a and the first output winding 201b are coupled to each other by electromagnetic coupling to transfer power and voltage. The power supply winding 201c is coupled to the pulse width modulation unit 202, to provide an enabling signal to the pulse width modulation unit 202.

The pulse width modulation unit 202 is coupled between the input winding 201a and a reference voltage via a switch (e.g. a transistor), and functions to control the time duration of sustained current flow in the input winding 201a, thereby adjusting the voltage on the windings.

The rectifier unit 203 is coupled to the output winding 201b, to rectify the current outputted by the output winding, so as to supply an input voltage to the DC-to-DC converters 204a and 205a. Similar to the first embodiment, the DC-to-DC converter 204a supplies a first output voltage to the connector 204b, and the DC-to-DC converter 205a supplies a second output voltage to the connector 205c via the protocol unit 205b.

FIGS. 2A-A, 2A-B and 2A-C are a detailed circuit diagram which exemplifies the embodiment of FIG. 2. Nodes V1, V2, V3, V+ and V− in FIGS. 2A-A, 2A-B and 2A-C denote common nodes. In FIGS. 2A-A, 2A-B and 2A-C, the components 201, 201a, 201b, 201c, 202, 203, 204a, 204b, 205a, 205b and 205c correspond to the components with the same reference symbols in FIG. 2. The various components shown in FIGS. 2A-A, 2A-B and 2A-C are similar to components in FIGS. 1A-A and 1A-B having same or similar reference symbols. Additionally, Q201 is a synchronized rectifier that converts high frequency AC current to DC current respectively. U302 and U402 are voltage stabilizing chips.

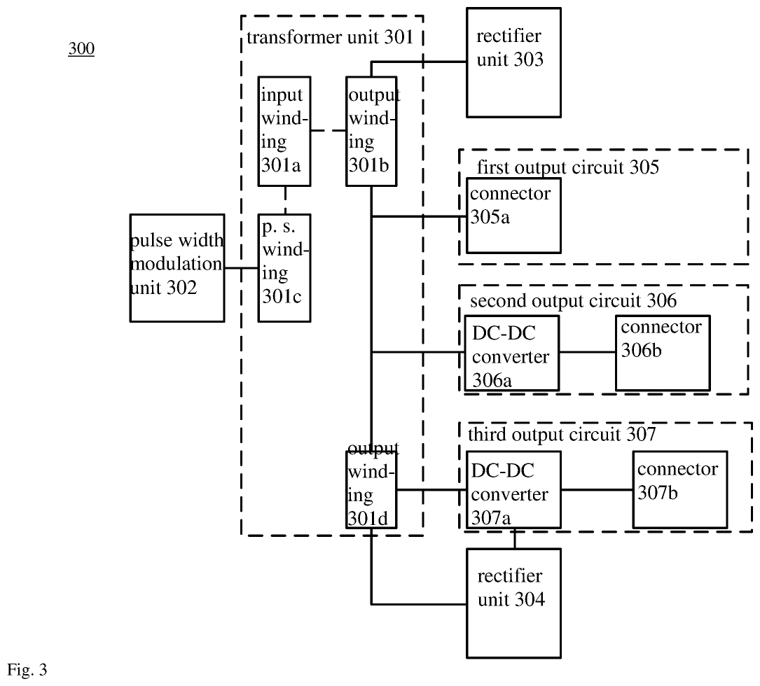

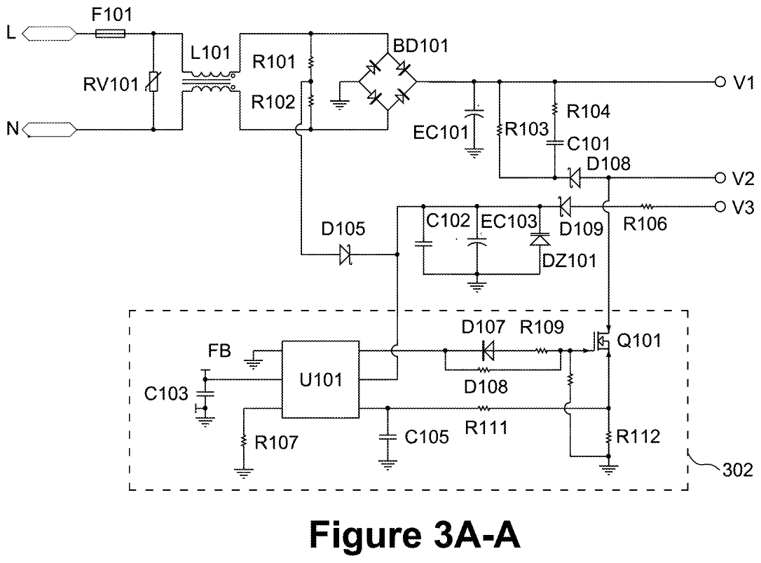

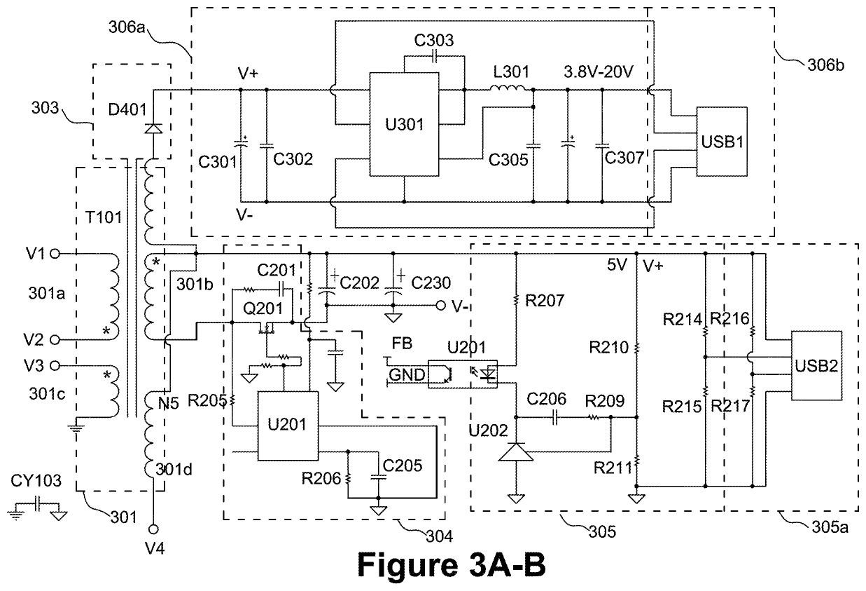

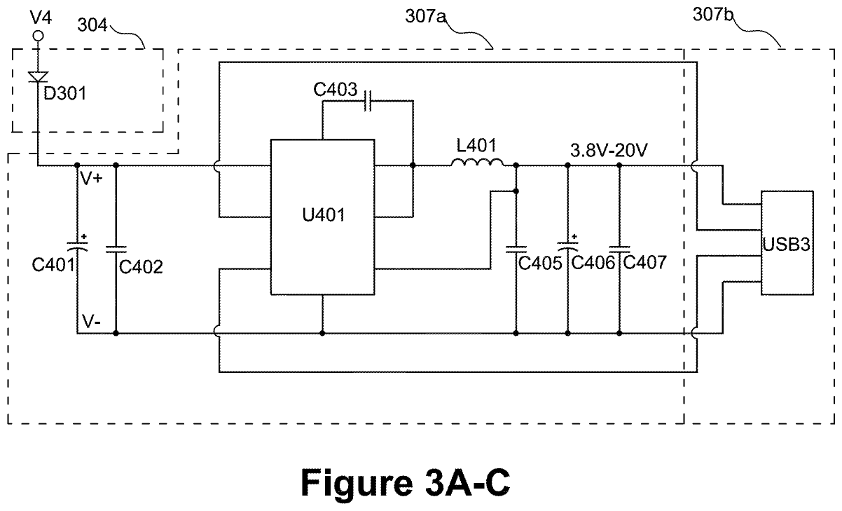

FIG. 3 schematically illustrates the electrical circuit configuration of a power supply device according to a third embodiment of the present invention.

As shown in FIG. 3, the power supply device 300 includes transformer unit 301, pulse width modulation unit 302, rectifier units 303 and 304, first output circuit 305, second output circuit 306, and third output circuit 307.

The transformer unit 301 may include input winding 301a, first output winding 301b and power supply winding 301c. The input winding 301a and the first output winding 301b are coupled to each other by electromagnetic coupling to transfer power and voltage. The power supply winding 301c is coupled to the pulse width modulation unit 302, to provide an enabling signal to the pulse width modulation unit 302. The pulse width modulation unit 302 is coupled between the input winding 301a and a specified voltage signal (e.g., the ground) via a switch, and functions to control the time duration of sustained current flow in the input winding 301a, thereby adjusting the voltage on the windings.

The rectifier unit 303 is coupled to the first output winding 301b, to rectify the current outputted by the first output winding, so as to supply a first DC voltage signal to the first output circuit 305. In this embodiment, the first output circuit 305 directly outputs the first DC voltage signal to the output connector 305a; i.e., the first output signal of the first output circuit is the first DC voltage signal.

Similarly, the first output winding 301b also provides the first DC voltage signal to the second output circuit 306. The DC-to-DC converter 306a in the second output circuit 306 converts the first DC voltage signal, and outputs the converted DC voltage signal at the connector 306b as a second output signal.

The output winding 301d is coupled to output winding 301b; they can be coupled in parallel or in series. The rectifier unit 304 rectifies the current outputted by the output winding 301d, so as to supply a second DC voltage signal to the third output circuit 307. The DC-to-DC converter 307a performs DC voltage conversion for the second DC voltage signal (raising or lowering the voltage), and outputs a third output voltage signal at the connector 307b.

The first to third output circuit can each include a protocol unit (not shown), which recognizes the charging protocol of the device being charged, and determines and controls the voltage of the respective output circuit accordingly.

The third output circuit 307 may further include a diode and a capacitor coupled in series with the winding 301d, where the DC-to-DC converter 307a is coupled to the capacitor to obtain a DC current.

FIGS. 3A-A, 3A-B and 3A-C are a detailed circuit diagram which exemplifies the embodiment of FIG. 3. Nodes V1, V2, V3, V4, V+ and V− in FIGS. 3A-A, 3A-B and 3A-C denote common nodes. In FIGS. 3A-A, 3A-B and 3A-C, the components 301a, 301b, 301c, 301d, 302, 303, 305, 305a, 306, 306a, 306b, 307, 307a, 307b, and 304 correspond to the components with the same reference symbols in FIG. 3. The various components shown in FIGS. 3A-A, 3A-B and 3A-C are similar to components in FIGS. 1A-A and 1A-B and FIGS. 2A-A, 2A-B and 2A-C having same or similar reference symbols.

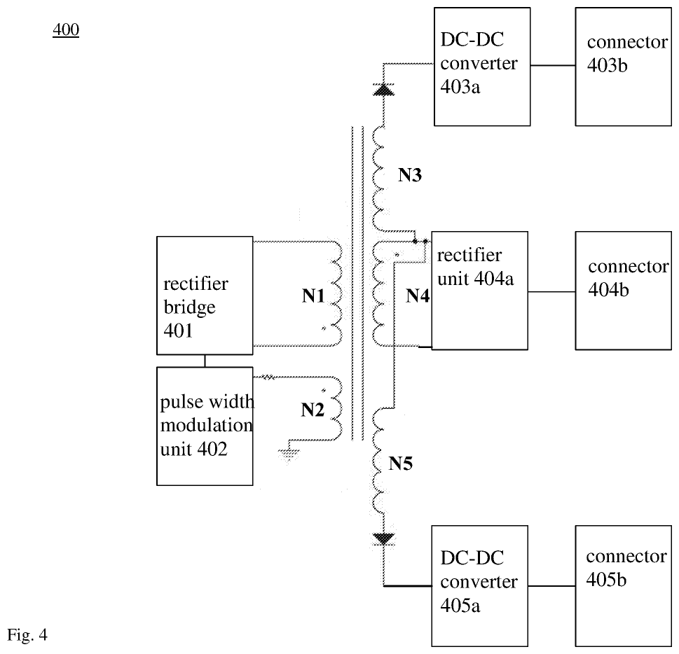

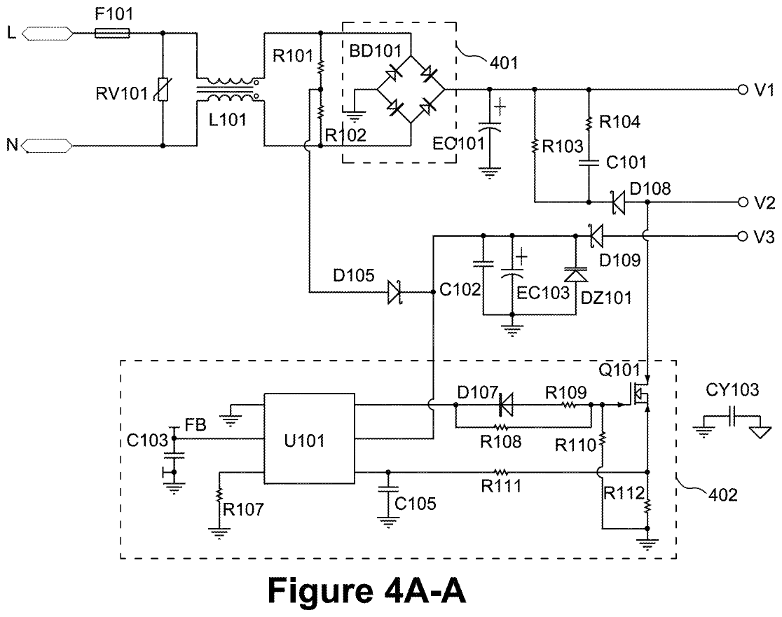

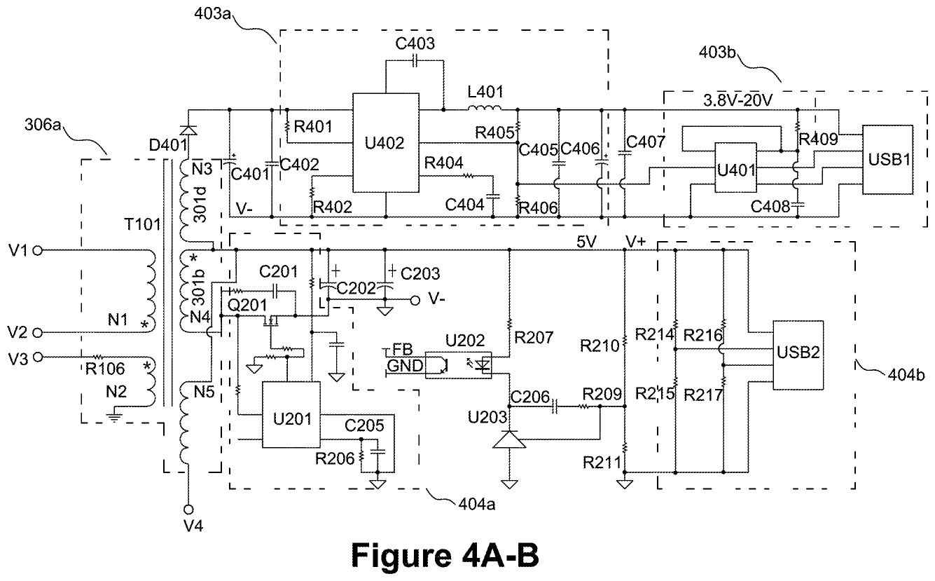

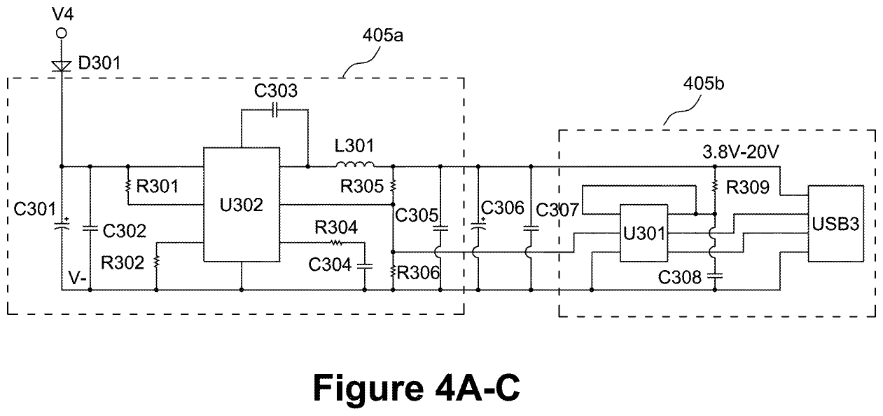

FIG. 4 illustrates an electrical circuit according to embodiments of the present invention.

The power supply device 400 includes a rectifier bridge 401 to rectify the received AC voltage signal, and a capacitor (not shown) to processes the DC current signal from the rectifier (including smoothing, filtering, buffering) before outputting it to the transformer. A pulse width modulation unit 402 and a transistor switch (not shown) achieves power conversion.

In this embodiment, the primary winding N1 of the transformer is coupled to the secondary windings N3-N5, to achieve designed voltage transfer under the control of the pulse width modulation unit 402. Windings N3 and N5 are respectively coupled in series with winding N4; thus, relative to the input signal received by the rectifier unit 404, the DC-to-DC converters 403a and 405a receive higher voltage input signals.

Although in the illustrated example the windings N3 and N5 are coupled in series with winding N4, it should be understood that windings N3 and N5 can alternatively be coupled in parallel with winding N4. As another alternative, windings N3 and N5 may be omitted, and the DC-to-DC converters 403a and 405a can directly receive the voltage from winding N4.

FIGS. 4A-A, 4A-B and 4A-C are a detailed circuit diagram which exemplifies the embodiment of FIG. 4. Nodes V1, V2, V3, V4, V+ and V− in FIGS. 4A-A, 4A-B and 4A-C denote common nodes. In FIGS. 4A-A, 4A-B and 4A-C, the components 401, 402, N1-N5, 403a, 403b, 404a, 404b, 405a and 405b correspond to the components with the same reference symbols in FIG. 4. The various components shown in FIGS. 4A-A, 4A-B and 4A-C are similar to components in FIGS. 1A-A and 1A-B, FIGS. 2A-A, 2A-B and 2A-C, and 3A-A, 3A-B and 3A-C having same or similar reference symbols.

For conventional wall-mounted power supply receptacles, because their physical size need to meet certain standards, their functions are often limited, e.g., conventional wall-mounted power supply receptacles often have few output connectors or can only supply a single voltage. Wall-mounted power receptacles according to embodiments of the present invention can provide more output connectors and multiple output voltages with the same physical space constraints as conventional devices.

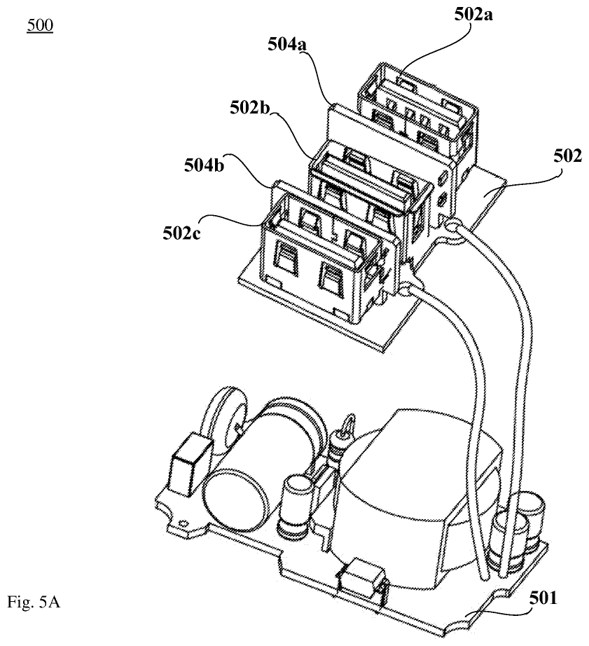

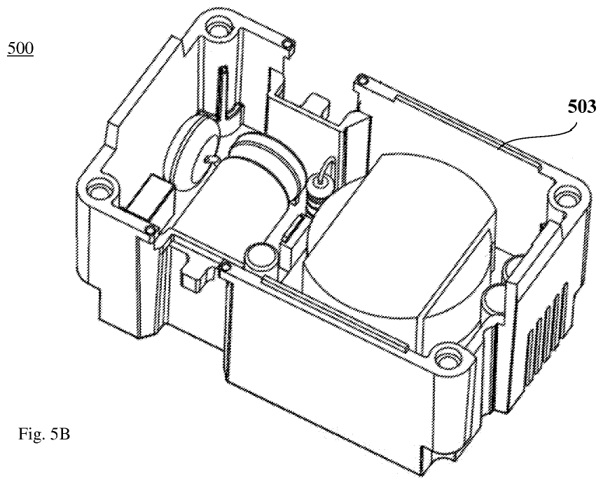

Refer to FIGS. 5a and 5b, where FIG. 5a illustrates an electrical circuit board of a wall-mounted power supply receptacle and FIG. 5b illustrates an assembly of a wall-mounted power supply receptacle according to embodiments of the present invention.

The wall-mounted power receptacle 500 includes:

A first circuit board assembly 501, which includes a first circuit board, a transformer unit, and a rectifier unit, where the transformer unit and rectifier unit are mounted on the first circuit board;

A second circuit board assembly 502, which includes a second circuit board, a DC-to-DC converter and multiple output connectors, where DC-to-DC converter is mounted on a first side of the second circuit board and the multiple output connectors 502a-502c are mounted on a second side of the second circuit board opposite the first side. The wall-mounted power supply receptacle 500 further includes a protocol unit, configured to recognize the charging protocol of the device being charged, and controls the voltage of the output connectors according to the protocol.

It should be understood that one or more of the rectifier unit, DC-to-DC converter, protocol unit can be mounted on individual circuit boards, where the multiple individual circuit boards are connected by wires.

The wall-mounted power receptacle 500 further includes a housing 503 for accommodating the above components. More specifically, the first circuit board assembly 501 is installed in the housing (as shown in FIG. 5b), and a thermal adhesive is filled into the housing (potting), so that the thermal adhesive seals the first circuit board assembly 501 in the housing to form an integral unit. The thermal adhesive can seal the components, and provides waterproof, dust proof, moisture proof, vibration resistance, and heat dissipation functions. The thermal adhesive may be, for example, a single part or two part silica gel, a single part or two part resin, a single part or two part epoxy resin, etc.

In one embodiment, the components mounted on the first side of the second circuit board 502 (e.g. the DC-to-DC converter and/or the protocol unit) may also be sealed with a thermal adhesive, to provide better heat dissipation and sealing of the DC-to-DC converter and/or the protocol unit.

Other board members 504a and 504b, such as a third circuit board, are also mounted on the second side of the second circuit board 502. The board members are substantially perpendicular to the second circuit board 502. The output connector 502a is mounted on the board member 504a, and output connector 502c is mounted on the board member 504b. The output connector 502b may be mounted on the board member 504a or 504b or the second circuit board 502. This way, the space utilization with the housing 503 is improved.

It can be seen that when the wall-mounted power receptacle according to embodiments of the present invention operates, the transformer has a power transfer functions and a separation function, and allows multiple output circuits. By using the protocol units, the power receptacle can provide adaptive charging in accordance with the protocol of the device being charged, so that the wall-mounted power supply receptacle 500 can output multiple different charging voltages, to automatically adapt to supporting 3.8-20V charging voltage, which can meet the requirements of most devices. Moreover, the sealed structure by using a thermal adhesive to encapsulate the entire circuit, the product has improved heat dissipation, waterproof and moisture proof properties, as well as fire resistance and flame proof properties. As a result, the product is versatile, safe, and reliable. The product has a simple electrical circuit and low cost, is convenient to install, and has reliable properties.

It will be apparent to those skilled in the art that various modification and variations can be made in the power receptacle of the present invention without departing from the spirit or scope of the invention. Thus, it is intended that the present invention cover modifications and variations that come within the scope of the appended claims and their equivalents.

What is claimed is:

1. A wall mounted power supply device, comprising:
a transformer unit, including an input winding and at least one output winding; and
at least one output circuit corresponding to the at least one output winding, wherein each output circuit includes:
a rectifier unit, coupled to the corresponding output winding, configured to rectify a current of the output winding to generate a DC (direct current) voltage signal;
an output connector; and
a DC-to-DC converter, configured to generate an output signal at the output connector based on the DC voltage signal generated by the rectifier unit.

2. The wall mounted power supply device of claim 1, further comprising a housing, wherein the transformer unit and the rectifier unit are sealed within the housing by a thermal adhesive to form a sealed integral unit with the housing.

3. The wall mounted power supply device of claim 1, wherein the rectifier unit rectifies the current on the output winding so that the output winding outputs the DC voltage signal; or
wherein the rectifier unit receives a voltage signal output by the output winding and generates the DC voltage signal based thereon.

4. The wall mounted power supply device of claim 1, wherein the output circuit further includes:
a protocol unit, configured to recognize a charging protocol of a device being charged at the output connector, and to control a voltage of the output signal at the output connector according to the charging protocol.

5. The wall mounted power supply device of claim 1, wherein the transformer unit further includes:
a pulse width modulation unit, coupled to the input winding, configured to control a time duration of sustained current flow in the input winding.

6. The wall mounted power supply device of claim 5, wherein the transformer unit further includes:
a power supply winding, coupled to the pulse width modulation unit, configured to supply an enable signal to the pulse width modulation unit.

7. A wall mounted power supply device, comprising:
a transformer unit, including an input winding and an output winding;
a rectifier unit, coupled to the output winding, configured to rectify a current of the output winding to generate a DC (direct current) voltage signal;
at least two output connectors; and
at least two output circuits coupled in parallel, configured to respectively generate independent output signals at respective output connectors based on the DC voltage signal, wherein each output circuit includes a DC-to-DC converter configured to convert the DC voltage signal.

8. The wall mounted power supply device of claim 7, further comprising a housing, wherein the transformer unit and the rectifier unit are sealed within the housing by a thermal adhesive to form a sealed integral unit with the housing.

9. The wall mounted power supply device of claim 7, wherein the rectifier unit rectifies the current on the output winding so that the output winding outputs the DC voltage signal; or
wherein the rectifier unit receives a voltage signal output by the output winding and generates the DC voltage signal based thereon.

10. The wall mounted power supply device of claim 6, wherein the output circuit further includes:
a protocol unit, configured to recognize a charging protocol of a device being charged at the output connector, and to control a voltage of the output signal at the output connector according to the charging protocol.

11. The wall mounted power supply device of claim 10, wherein the DC-to-DC converter and the protocol unit are sealed in the housing by the thermal adhesive.

12. The wall mounted power supply device of claim 7, wherein the transformer unit further includes:
a pulse width modulation unit, coupled to the input winding, configured to control a time duration of sustained current flow in the input winding; and
a power supply winding, coupled to the pulse width modulation unit, configured to supply an enable signal to the pulse width modulation unit.

13. A wall mounted power supply device, comprising:
a housing;
a first circuit board assembly, including:
a first circuit board;
a transformer unit mounted on the first circuit board, including an input winding and an output winding coupled to each other; and
a rectifier unit, mounted on the first circuit board, coupled to the output winding, configured to rectify a current of the output winding to generate a DC (direct current) voltage signal; and
a second circuit board assembly, including:
a second circuit board;
an output connector; and
a DC-to-DC converter, mounted on the second circuit board, configured to convert the DC voltage signal to generate an output signal at the output connector;
wherein the first circuit board assembly is sealed within the housing by a thermal adhesive to form a sealed integral unit with the housing.

14. The wall mounted power supply device of claim 13, wherein the second circuit board assembly further includes:
a protocol unit, configured to recognize a charging protocol of a device being charged at the output connector, and to control a voltage of the output signal at the output connector according to the charging protocol.

15. The wall mounted power supply device of claim 13, wherein the DC-to-DC converter is mounted on a first side of the second circuit board, and the output connector is mounted on a second side of second circuit board opposite the first side.

16. The wall mounted power supply device of claim 15, wherein the second circuit board assembly further includes a board member mounted on the second side of the second circuit board, wherein the board members is perpendicular to the second circuit board, and wherein the output connector is mounted on the board member.

17. The wall mounted power supply device of claim 15, wherein the DC-to-DC converter and the protocol unit are sealed in the housing by the thermal adhesive.
